(19) United States
(12) Patent Application Publication
(10) Pub. No.: US 2010/0015491 A1
(43) Pub. Date: Jan. 21, 2010

(54) SOLID OXIDE FUEL CELL STACK FOR PORTABLE POWER GENERATION

(75) Inventor: Jean Yamanis, South Glastonbury, CT (US)

Correspondence Address: KINNEY & LANGE, P.A., THE KINNEY & LANGE BUILDING, 312 SOUTH THIRD STREET, MINNEAPOLIS, MN, 55415, US

(73) Assignee: UNITED TECHNOLOGIES CORPORATION, Hartford, CT (US)

(21) Appl. No.: 12/515,236

(22) PCT Filed: Aug. 17, 2005
(86) PCT No.: PCT/US05/29417

§ 371 Date: May 15, 2009

(51) Int. Cl. H01M 8/10

(52) U.S. Cl. 429/30

(57) ABSTRACT

A solid oxide fuel cell module for use in a portable power supply system. The solid oxide fuel cell module includes a housing with a walled structure defining a substantially enclosed interior cavity, wherein the housing includes an outer wall surface and inner wall surface. The solid oxide fuel cell module also includes an aperture extending through the walled surface from the outer wall surface to the inner wall surface of the housing in fluid communication with the interior cavity. A tri-layer solid oxide fuel cell may be mounted to the housing and aligned to substantially cover the aperture.

### FIELD OF THE INVENTION

The present invention relates generally to a solid oxide fuel cell stack, and more particularly, to a solid oxide fuel cell stack architecture including surface-mounted intermediate temperature solid oxide fuel cells.

### SUMMARY OF THE INVENTION

A solid oxide fuel cell module for use in a portable power supply system. The solid oxide fuel cell module includes a housing with a walled structure defining a substantially enclosed interior cavity, wherein the housing includes an outer wall surface and an inner wall surface. The solid oxide fuel cell module also includes an aperture extending through the walled structure from the outer wall surface to the inner wall surface of the housing in fluid communication with the interior cavity. A tri-layer solid oxide fuel cell may be mounted to housing and aligned to substantially cover the aperture.

### BACKGROUND OF THE INVENTION

Solid oxide fuel cells (SOFCs) have not been pursued as a feasible solution for providing a portable power supply in the sub-1 kw power range. SOFCs operate at high temperatures and are usually thought of as appropriate for stationary power generation applications. One reason for not using SOFCs in portable power supply applications, is the length of time, which can be measured in tens of minutes, it typically takes to get an SOFC system up to operating temperature, which may be in the range of 650° C.-900° C. This long start-up time combined with the degradation that can occur in SOFCs from repeated thermal cycling makes them more suitable for applications where a slow heat-up to a steady-state operating condition is acceptable, such as stationary power generation applications.

In order to use SOFCs in a portable application, a compact stack architecture having a high resistance to thermal cycling degradation needs to be developed. Typical SOFCs, based on ceramic electrode supported designs, may require geometries that are not suitable for compact stack architectures, in order to achieve the required thermal cycling durability.

The advent of metal-supported intermediate temperature solid oxide fuel cells (N. Brandon et al., “Development of metal supported solid oxide fuel cells for operation at 500-600° C.”, ASM Materials Solution Conference, Oct. 13-15 (2003), Pittsburgh, Pa. ) enables stack architectures that are both compact and resistant to thermal cycling degradation. Stack architectures suitable for sub-1 kw applications will be described herein.

### DESCRIPTION OF THE DRAWINGS

The present invention may be understood with reference to the drawings, in which:

FIG. 1 is plan view of a repeat unit within a solid oxide fuel cell stack according to an embodiment of the present invention.

FIG. 1A is partial sectional view taken along line A-A of FIG. 1, showing the repeat unit of FIG. 1.

FIG. 1B is a sectional view taken along line B-B of FIG. 1, showing the repeat unit of FIG. 1.

FIG. 1C is a sectional view taken along line B-B of another embodiment of the invention

FIG. 1D is sectional view taken along line A-A of FIG. 1, showing the repeat unit of FIG. 1

FIG. 2 is a top-down plan view of a solid oxide fuel cell deposited on a metal substrate according to an embodiment of the present invention.

FIG. 3, is a bottom-up plan view of a metal substrate configured to support a solid oxide fuel cell according to an embodiment of the present invention.

FIG. 4 is a plan view of a housing configured to support a surface-mounted solid oxide fuel cell according to an embodiment of the present invention.

FIG. 4A is a orthographic sectional view of the housing of FIG. 4 along line A-A.

FIG. 4B is an enlarged sectional view of portion, B, of the housing of FIG. 4A.

FIG. 5 is a plan view of an embodiment of a repeat unit of a fuel cell stack according to the present invention.

FIG. 5A is a section view along line A-A of FIG. 5.

FIG. 6 is a perspective view of a suspended stack composed of repeat units, as shown in FIG. 5.

FIG. 7 is a schematic view of a portable power generation system, using a suspended solid oxide fuel cell stack configuration like that of FIG. 6.

### DETAILED DESCRIPTION

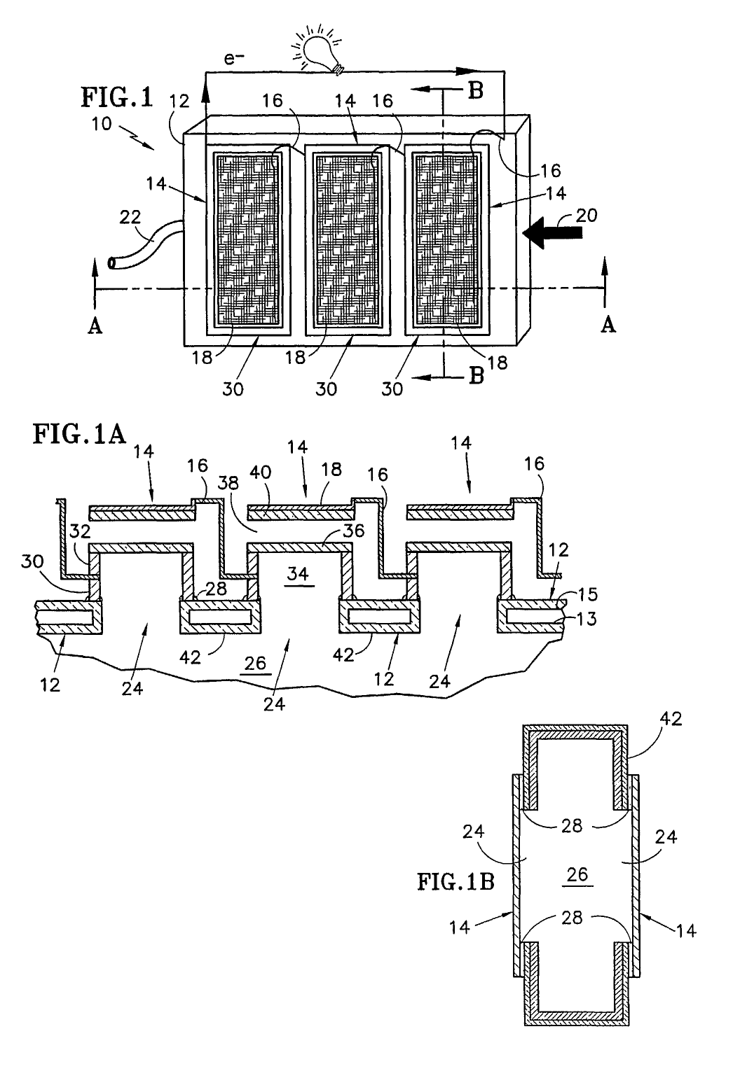

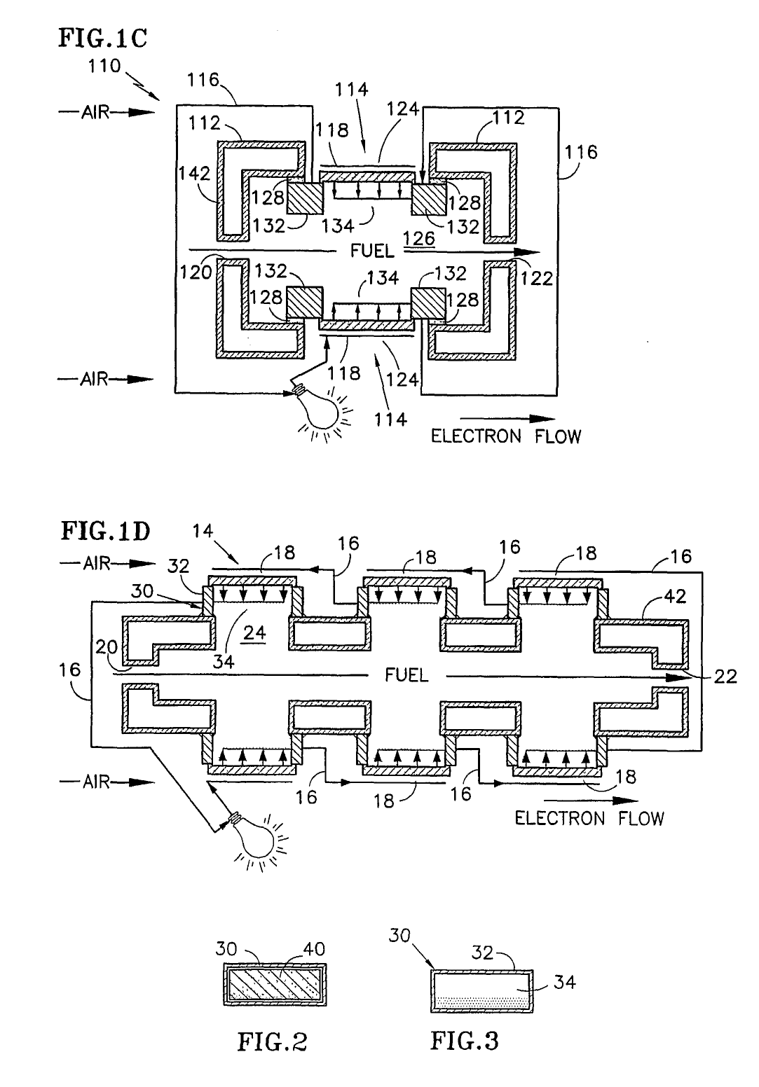

Referring to FIG. 1, there is shown a stack repeat unit 10 according to an embodiment of the present invention. Stack repeat unit 10 forms the basis for a surface-mounted intermediate-temperature solid oxide fuel cell stack architecture configured to produce high specific power and withstand rapid thermal cycling, as will be described herein. Stack repeat unit 10, may also be referred to as a solid oxide fuel cell module.

Stack repeat unit 10, may include a housing 12 configured to support a plurality of solid oxide fuel cell (SOFC) assemblies 14, and electrical interconnects 16, which couple with and electrically connect adjacent SOFC assemblies 14. Each SOFC assembly 14 includes a current collector 18 attached thereto and coupled for electrical connection with electrical interconnects 16, as shown in FIGS. 1 and 1A. Each SOFC assembly 14 includes a current collector 22, which may also be a metal support for the solid oxide fuel cell.

Housing 12 my include a walled structure. The walled structure of housing 12 may define an interior cavity 26. The walled structure of housing 12 may include an inner surface 13 and an outer surface 15.

In FIG. 1, housing 12 may be configured to intake a reactant gas to an interior of housing 12 through a fuel inlet 20 and expel a spent reactant gas through an exhaust outlet 22. Housing 12, as shown in FIG. 1A, may include a plurality of apertures 24 and at least one interior cavity 26. SOFC assemblies 14 are sized to cover apertures 24 and overlap with a portion of the outer surface of housing 12. This overlap may be suitable for bonding SOFC assemblies 14 to housing 12, as described herein below. Housing 12, as shown in FIG. 1B, may include apertures 24 on opposed sides thereof. SOFC assemblies 14 may be positioned to substantially cover each aperture 24.

Housing 12 may be made of a metal alloy that forms a dielectric scale after well known in the art oxidation processing at elevated temperatures or has a dielectric scale deposited thereon. For example, Fe—Cr—Al, or fecralloys, which are commercially available under such tradenames as Aluchrom Y, Aluchrom YHf, Kanthal alloys, 18SR stainless steel, and other aluminum containing alloys which may form an alumina scale by oxidation, may be used for housing 12. Similarly, metal alloys that can form or be coated with alumina, or some other dielectric material, such as ferittic stainless steels, and nickel-based alloys having a suitable coefficient of thermal expansion may be used to form housing 12. Housing 12 may be formed from a thin sheet or foil, when made of a metal alloy. The dielectric scale of housing 12 may prevent an electrical short between SOFC assemblies 14. It will be understood, by those of skill in the art, that housing 12 may be made of any number of suitable materials.

Housing 12 may be made of a ceramic material. For example, a yitria stabilized zirconia material may be used to form housing 12. A strontium-doped barium titanate ceramic also may be used to form housing 12. Varying the composition of the strontium-doped barium titanate may be used to match the coefficient of thermal expansion with that of SOFC assemblies 14. Housing 12 may also be made of glass-ceramic, metal ceramic composite materials with or without dielectric barriers or scales. In a ceramic material embodiment of housing 12, at least one inner cavity 26, or a plurality of inner cavities connected by reactant gas passages (not shown), may be used to supply reactant gas to SOFC assemblies 14 via communication with apertures 24. A ceramic embodiment of housing 12 may provide electrical insulation to inherently prevent shorting between adjacent SOFC assemblies 14.

SOFC assemblies 14 may be bonded to housing 12 to form a seal 28 as shown in FIG. 1A and FIG. 1B. Bonding between housing 12 and SOFC assemblies 14 occurs at the overlap surrounding apertures 24 between housing 12 and SOFC assemblies 14. Seal 28 prevents a reactant gas inside cavity 26 from reacting with a reactant gas outside of housing 12. Typically, during operation a fuel gas containing hydrogen flows through fuel inlet 20 into cavity 26. An oxidizing gas, such as air, flows around the outer surface of housing 12. SOFC assemblies 14 because of their ion conductivity and electron conductivity enable a controlled electro-chemical reaction to occur and electrical power to be generated from this controlled reaction. Mixing of reactant gases directly may result in a combustion reaction that may damage the system.

FIG. 1A, shows a sectioned view of stack repeat unit 10. It will be understood with reference to FIG. 1A, that SOFC assemblies 14 may include a metal support 30 having a non-porous region 32 and a porous region 34. SOFC assemblies 14 further may include an electrode layer 36, an electrolyte layer 38, and an electrode layer 40. SOFC assemblies 14 belong to a class of solid oxide fuel cell systems known in the literature as intermediate temperature solid oxide fuel cells. Intermediate temperature solid oxide fuel cells typically operate at temperatures below 700° C. (N. Brandon et al., “Development of metal supported solid oxide fuel cells for operation at 500-600° C.”, ASM Materials Solution Conference, Oct. 13-15 (2003), Pittsburgh, Pa.; A. Weber et al., J. Power Sources, vol. 127, 273 (2004)).

Metal support 30 may be any suitable alloy configured such that a non-porous region 32 surrounds a porous region 34. Non-porous region 32 may be suitable for bonding and sealing SOFC assemblies 14 to housing 12 using a sealing material. Examples of sealing materials include active-metal brazes, metal alloys with reactive oxide components, glasses, glass ceramics, or other materials known in the art. Porous region 34 may be manufactured in any number of ways including chemical etching, laser drilling, electron beam drilling, wire electro-discharge machining (EDM), and other methods known in the art. Porous region 34 may permit reactant gas within interior cavity 26 to come in contact with electrode layer 36 and an electrochemical reaction may proceed. Suitable alloys include, but shall not be limited to, ferritic stainless steels, 400 series stainless steels, nickel-based super alloys, austenitic steels, and other alloys that form electron conducting protective scales, such as chromia. Suitable bimetallic materials may also be used as metal support 30. The structure of metal support 30, including porous region 34 surrounded by non-porous region 32, permits surface mounting of SOFC assemblies 14 to the outer surface of housing 12.

Electrode layer 36 may be deposited on porous region 34 of metal support 30. Typically, electrode layer 36 may be an anode electrolyte made of a porous cermet material. For example, nickel, copper, ruthenium, or other metals and the electrolyte material, which could be any of the intermediate temperature solid oxide electrolyte systems. Additionally, anode systems may be made of mixed electronic/ionic conducting materials may be used. For example, doped titanates with minor metallic components may be used. It will be understood by those skilled in the art that electrode layer 36 may be a cathode layer and the reactant gas within cavity 26 may be an oxidizing reactant.

Dense electrolyte layer 38 may be deposited on electrode layer 36, such that the electrolyte substantially covers electrode layer 36. Dense electrolyte layer 38 may overlap to some extent with non-porous region 32 in order to close any potential path for reactant gas to diffuse and leak to the exterior of housing 12. Any suitable ceramic deposition technique may be used to deposit electrolyte layer 38. Typically, electrolyte layer 38 may be deposited using elelctrophoretic deposition, followed by consolidation and sintering. Electrolyte layer 38 may be a rare earth doped ceria, preferably gadolinia doped ceria material. Other electrolyte materials include, but shall not be limited to, the family of doped lanthanum gallate materials, for example, magnesium and strontium doped lanthanum gallate. Additionally, thin film scandium stabilized zirconia could be used as electrolyte layer 38. Typically, intermediate temperature solid oxide electrolyte systems are capable of attaining desirable oxygen ion conductivity at temperatures in the range of around 500° C. to 700° C.

Electrode layer 40 may be deposited on electrolyte layer 38. Typically, electrode layer 40 is deposited after electrolyte layer 38 and electrode layer 36 have been deposited, fired, or sintered. Electrode layer 40 may be a porous cathode electrode. A number of suitable cathode systems may be used. The cathode system could be a composite ceramic having an ion-conducting phase and an electron-conducting phase with a microstructure permitting three-dimensional percolation of both ions and electrons. For example, cathode electrode layer 40 may be a gadolinia-doped ceria as the ion-conducting phase and doped lanthanum ferrite as the electron-conducting phase. Typically, the ion-conducting phase may be derived from the electrolyte system and the electron-conducting phase may be any suitable inorganic oxide having good electronic conductivity and good activity for oxygen reduction. A good mixed ionic electronic conductor material at the operating temperature range of the SOFC may be used alone as the electrode thus obviating the need to use the ion-conducting material in this layer. It will be understood by those skilled in the art that electrode layer 40 may be an anode electrode and the reactant gas supplied to the anode be a hydrogen containing fuel.

Current collectors 18 may be attached to electrode layer 40 to provide a low resistance path for electron flow to or from electrode layer 40 during the electrochemical reaction of SOFC assemblies 14 in the presence of reactant fuels at the required activation temperature. Electrical interconnects 16 may form an electrical link between the anode and cathode of adjacent SOFC assemblies 14 mounted to the exterior surface of housing 12. Because of the surface-mounted configuration of SOFC assemblies 14, electrical interconnects 16 do not have to cross a reactant containment barrier, or housing wall, to electrically connect one or more SOFC assemblies 14.

According to the embodiment of FIG. 1A, SOFC assemblies 14 are mounted to the external surface of housing 12. As noted above, housing 12 should have a suitable dielectric scale 42 to provide electrical insulation to each SOFC assembly 14. Dielectric scale 42 insulates SOFC assemblies 14 ensuring that only electrical current path between adjacent SOFC assemblies is electrical interconnects 16. In embodiments of the present invention using a housing that is not electrically conductive, for example a ceramic housing, dielectric scale 42 may be omitted.

In operation, as will be understood with reference to FIGS. 1 and 1A, a reactant gas, or hydrogen containing fuel, may enter housing 12 via fuel inlet 20 and may flow through inner cavity 26, apertures 24, and porous region 34, so that the hydrogen may react with oxygen ions at the triple point boundary (TPB) region as is well known in the art. The TPB region is near the interface of electrode layer 36 and electrolyte layer 38. Typically, the hydrogen containing gas is a reformate containing hydrogen and carbon monoxide. Oxygen in the oxidant or air gas may be reduced at electrode layer 40 to oxygen ions picking up electrons delivered by the current collector 18. The oxygen ions may be transported by ion conduction processes through electrode layer 40 and electrolyte layer 38 to react with the hydrogen at the TPB releasing electrons. The electrons released travel through electrode layer 36 to metal support 30 and then through electrical interconnect 16 to current collector 18 of the next SOFC assembly 14 and so on to complete the circuit with an external load. It will be understood that reversing anode layer 36 and cathode layer 40 may be desirable, in which case the reactant gases present within and outside housing 12 need to be reversed as is well known in the art.

FIG. 1B illustrates the symmetric design of housing 12 which may lead to lower manufacturing costs. However, other non-symmetric designs are within the scope of the invention. Current collectors 18, and the detailed layers of SOFC assemblies 14 have been omitted in order to simplify the illustration in FIG. 1B. Inner cavity 26 permits a reactant gas within the cavity to be in fluid communication with SOFC assemblies 14 mounted on opposed surfaces of housing 12. Each SOFC assembly 14 may be bonded to housing 12 to form seal 28 that prevents reactant gases from mixing and reacting in a way that may damage SOFC assemblies 14. The flat elongate box-like configuration of housing 12 enables a series of SOFC assemblies 14 to be mounted on opposite surfaces of housing 12. This enables construction of stack repeat unit 10 having compact size and capable of being suspended with other repeat units to form a robust and light weight stack that becomes the electric power generating component of a portable power generation system. Inner cavity 26 may be completely void or it may include lightweight structures to enhance gas redistribution, more uniform velocity field, and elimination of gas stagnant regions.

FIG. 1D shows a sectional view along line A-A of FIG. 1 and demonstrates how the complete electric circuit of the repeat unit 10 is configured. In this embodiment the fuel reactant flows through the internal cavity 26 of the repeat unit, while the air or oxidant gas flows externally to the repeat unit. Reverse mounting of the electrodes in the SOFC assembly 14 would require reversal of the gas flow streams as is well known in the art.

FIG. 1C shows another embodiment of a repeat unit 110 according to the present invention. Repeat unit 110 includes housing 112, SOFC assemblies 114, electrical interconnects 116, current collectors 118, fuel inlet 120, exhaust outlet 122, apertures 124, internal cavity 126, seals 128, metal support 130, non-porous region 132, and porous region 134. It is to be understood that multiple SOFC assemblies 114, multiple fuel inlets 120, and multiple exhaust outlets 122 are within the scope of the invention.

Repeat unit 110 includes SOFC assemblies 114 mounted to an inner surface of housing 112. sealing material forms a gas tight seal 128 between non-porous region 132 of metal support 130 and the interior wall 115 of housing 112. As noted above, housing 112 may include a dielectric scale or coating 142 to electrically isolate SOFC assemblies 114. Housing 112 may be made of electrically insulating materials that do not require dielectric scales or coatings.

FIG. 2 shows a top view of a tri-layer intermediate temperature solid oxide fuel cell supported by metal support 30 and having electrode 40 visible as the top layer of the tri-layer cell. In FIG. 2, cathode electrode layer 40 may be clearly seen. FIG. 3, shows a bottom view of the metal support of the tri-layer intermediate temperature solid oxide fuel cell of FIG. 2. As shown in FIG. 3, metal support 30 includes porous region 34 surrounded by non-porous region 32. The three layers of the tri-layer intermediate temperature solid oxide fuel cell are: the cathode electrode layer 40, shown in FIG. 2; an electrolyte layer, not shown; and an anode electrode layer, not shown. All three layers of the tri-layer cell are supported by metal support 30. The tri-layer structure substantially covers porous region 34 of metal support 30, thereby preventing reactant gases from mixing.

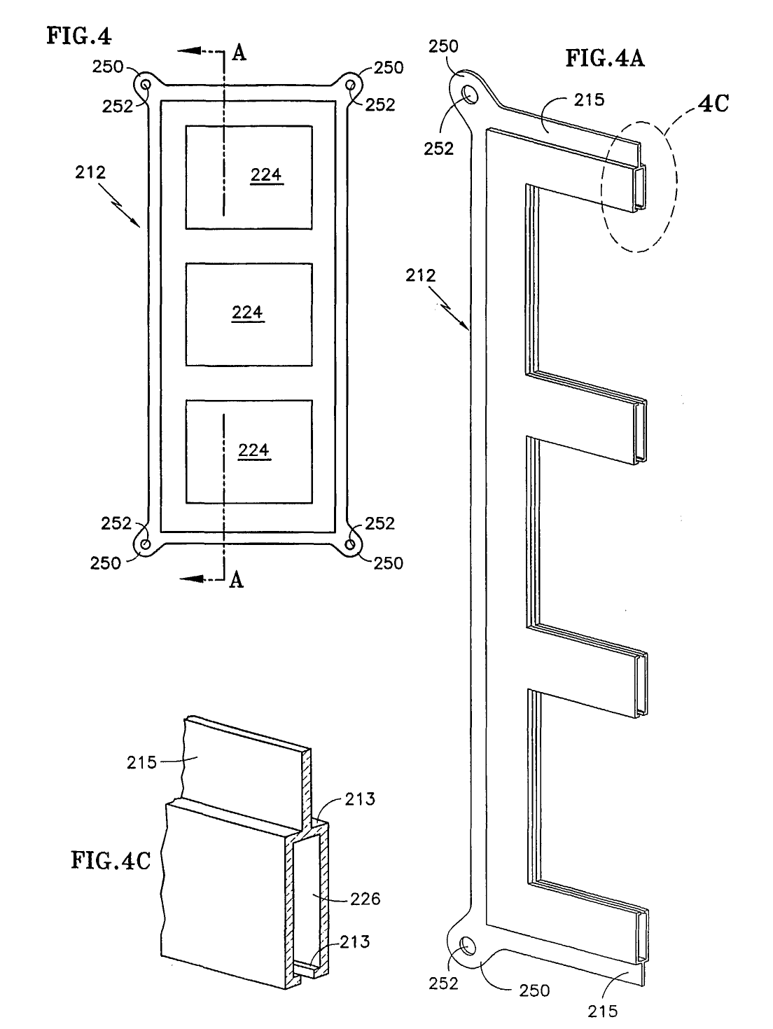

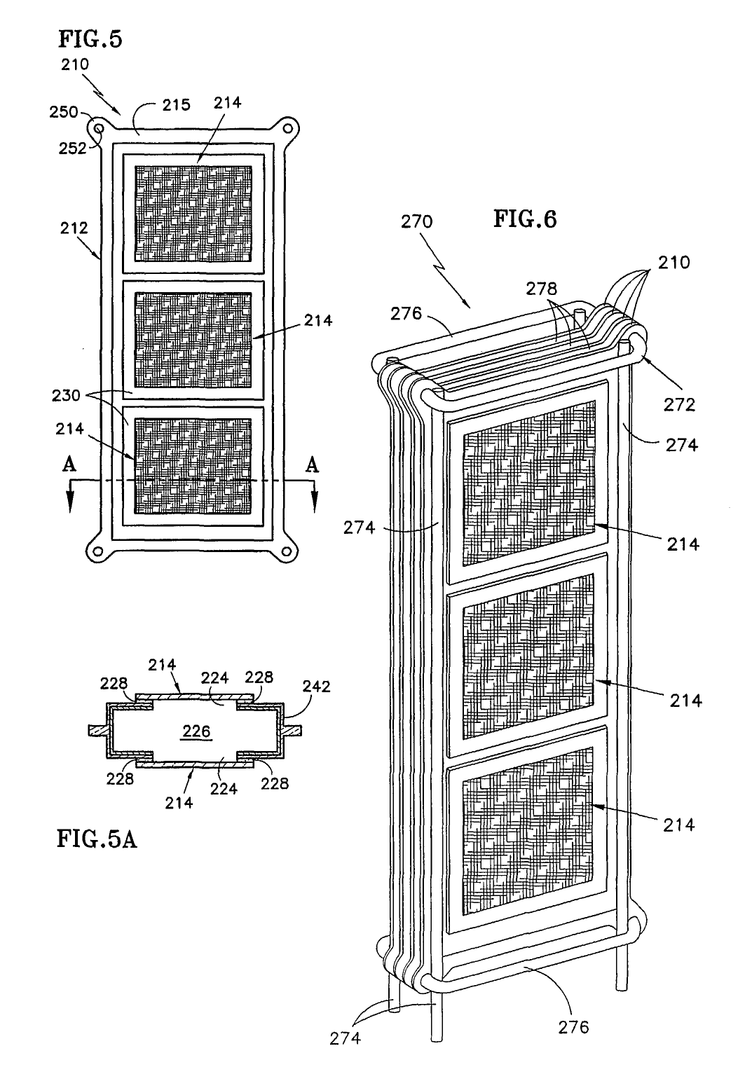

FIG. 4 shows a housing 212 according to another embodiment of a solid oxide fuel cell stack according to the present invention. Housing 212 may be formed of two thin sheets of metal alloy stamped into symmetric half shells. The symmetric half shells may be joined together to form housing 212. Housing 212 may include a length sized to accommodate at least one SOFC assembly. Preferably, the length of housing 212 is sized to accommodate a plurality of SOFC assemblies positioned adjacent one another along the length, as shown in FIGS. 1 and 5. Housing 212 may include a width, sized to accommodate at least one SOFC assembly within the width. It will be under stood that housing 212 may include a width sized to accommodate a plurality of SOFC assemblies positioned side-by-side along the width. Housing 212 may include a thickness that is relatively small when compared to the length and width, thereby forming a flat box-like structure. Housing 212 may have one or more reactant gas inlets (not shown), one or more exhaust outlets (not shown) to meet gas flow and distribution requirements.

Housing 212 may include a plurality of apertures 224 positioned on opposed sides thereof. Housing 212 may be configured to have apertures 224 aligned in pairs, a first of the pair on a front side thereof and a second of the pair on an opposed back side thereof. This pair configuration permits compact repeat units that have relatively large surface areas covered by SOFC assemblies. Housing 212 enables a surface-mounted stack architecture that may be robust to thermal cycling and may provide sufficient power density for many portable power generation system applications.

Housing 212 includes supports 250 located at the corners thereof. Supports 250 include mounting apertures 252, or some similar mounting structure configured to attach the housing to a frame. Supports 250 and mounting apertures 252 may be used to attach housing 212 to a frame, as discussed below with reference to FIG. 6. It will be understood that any suitable mounting structure may be used, for example, a clamping attachment, a bonding attachment, or a fastener attachment for coupling housing 212 with a frame.

As shown in FIG. 4, housing 212 includes three apertures 224 per side, for a total of six apertures 224. This configuration of apertures enables an efficient packaging of repeat units in an SOFC stack architecture, as will be shown below with reference to FIG. 6. It will be understood that any number of apertures per side may be used without departure from the scope of the present invention.

FIG. 4A, shows a sectioned view of housing 212 taken along line A-A of FIG. 4. FIG. 4B, shows an enlarged view of a portion of the section view of FIG. 4A. FIG. 4B illustrates the reinforcement bends or stiffeners 213 in housing 212 which provide structural strength to housing 212. Other stiffening structures may be stamped, embossed or attached to the flat surfaces of housing 212 to minimize deformation or warping of the structure. Conventional metal processes, such as, welding, diffusion bonding, friction welding, brazing, and other methods known in the art may be used to join halves of housing 212. FIG. 4B further illustrates, an overlapping flange 215 that may be used to weld, braze, or otherwise seal housing 212. Housing 212, may be constructed of two stamped shells. As shown, housing 212 includes inner cavity 226 that provides a reactant gas supplied thereto to be in fluid communication with apertures 224. The reinforcement bends or stiffeners 213 may be designed to provide gas flow redistribution in the inner cavity of housing 212. Other materials and designs may also be used to affect gas flow distribution so that the velocity field is quasi-uniform across the repeat unit width or substantially devoid of stagnant regions. Such materials and designs include but are not limited to ceramic structures of very high porosity, corrugated expanded metals having dielectric coatings of scales, wire mesh or wire cloths or wire wools with dielectric coatings or scales.

When housing 212 is made of alumina forming alloys, after joining the halves of the housing together, the housing is subjected to oxidation at suitable temperature, atmosphere and time to develop adherent alumina dielectric scale. Alternatively, the halves may be first oxidized to develop the adherent alumina dielectric scale and then joined together by suitable bonding processes using active metal brazes or metal brazes that bond to oxide surfaces or glasses or glass-ceramic materials. When housing 212 is made of a non-alumina forming alloy, a dielectric coating may be applied to the external surface thereof.

The structure shown in FIG. 5, schematically represents a stack repeat unit 210 according to an embodiment of the present invention. FIG. 5 shows a plan view of housing 212, as described with reference to FIG. 4. SOFC assemblies 214 may be bonded to housing 212 substantially covering apertures 224. With SOFC assemblies 214 bonded over each of apertures 224, housing 212 may be thereby sealed to prevent reactant gas within housing 212 to leak out of housing 212.

FIG. 5A, shows a cross section along line A-A of FIG. 5, similar to the structure described above with reference to FIG. 1B. Housing 212 may be joined together from two halves by any suitable joining processes, such as, welding, brazing, diffusion bonding, etc. Housing 212 may be oxidized or otherwise processed to develop or deposit a dielectic scale 242 on the surface. SOFC assemblies 214 may be sealed to housing 212 using seal 228. Seal 228 may be a metallic braze, an active metal braze, a glass, a glass ceramic, or any other seal material known in the art.

FIG. 6 shows a solid oxide fuel cell stack 270. Stack 270 includes a frame 272 configured to support a plurality of stack repeat units 210. Frame 272 may be any suitable material. For example, frame 272 may be a stainless steel or any other suitable metal alloy. It may be desirable that frame 272 be shock resistant and configured to isolate stack repeat units 210 from damage as a result of mechanical shocks, jolts, or other impacts to the portable power generation system. Additionally, it may be desirable for frame 272 to be electrically insulated. As shown in FIG. 6, frame 272 forms generally a three-dimensional rectangular parallelogram structure. A plurality of repeat units 210 may be suspended from frame 272, as will be described below. The spacers 278 may be metallic or ceramic washer-like structures interposed between adjoining repeat units 210 to ensure substantially uniform spacing between the repeat units, which in turn provides for substantially uniform reactant gas distribution flowing past the exterior surfaces of SOFC assemblies 214 supplying reactant gas to SOFC assemblies 214 for the electrochemical reaction and cooling. Electrically insulating high porosity materials may be placed between adjacent repeat units to affect the reactant gas flow distribution, if necessary.

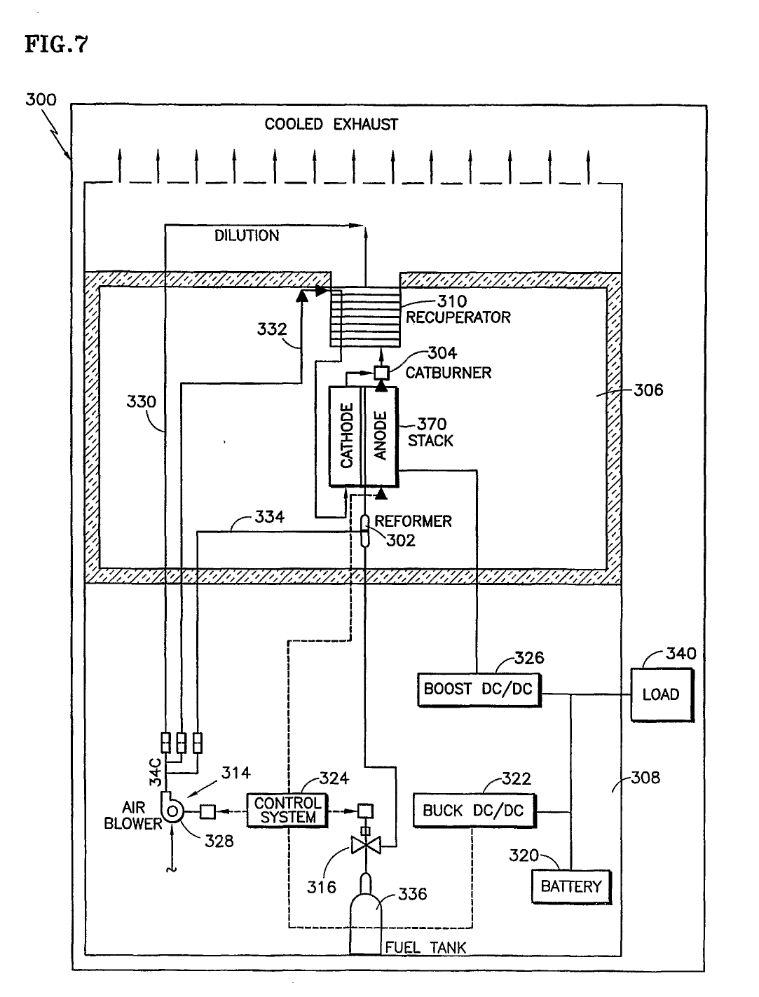

Frame 272 includes at least one suspension member 274 and at least one coupler member 276. Suspension member 274 may be configured to secure frame 272 and a plurality of suspended repeat units 210 within a hot section of a portable power generation system. Suspension member 274 may extend beyond the long dimension of repeat unit 210, thereby providing a structure for suspending SOFC stack 270 within a portable power generation system, as will be described below with reference to FIG. 7.

As shown in FIG. 6, frame 272 includes four suspension members 274. As noted above, frame 272 further includes a coupler member 276 configured to attach frame 272 to mounting apertures 252 of repeat units 210. A pair of coupler members 276, one at each end of the length dimension of repeat unit 210, may take the form of a rod-like loop structure that passes through mounting apertures 252, which may be located at each corner of housing 212 of repeat unit 210. Coupler member 276 may be attached to suspension member 272 by any suitable bonding or attachment mechanism. It will be understood that the coupler member may be configured to cooperate with the corresponding structure on housing 212, including a variety of fasteners, and other attachment means. Spacers 278 may be used between adjacent repeat units 210 to space the repeat units apart from one another permitting reactant gas to flow past housing 212 in a substantially uniform manner.

FIG. 7 illustrates schematically a portable power generator system 300, based on a low thermal mass stack architecture. Power generator system 300 may be capable of rapid start up and may achieve sufficient voltage and power for many portable applications. The system includes a reformer 302 which may be based on catalytic partial oxidation (CPOX) processes in order to convert a fuel, for example butane or other hydrocarbon fuels, into a reformate gas stream comprising primarily H₂, CO, H₂O, CO₂, and nitrogen from the air stream. Power generator system 300 includes a catalytic burner 304 that may facilitate the combustion of residual combustible gases exiting SOFC stack 370.

Power generator system 300 includes a high temperature compartment 306, or hot compartment, and an ambient temperature compartment 308. Housed within high temperature compartment 306 are reformer 302, SOFC cell stack 370, catalytic burner 304, and one or more recuperators 310. High temperature compartment 306 may be thermally insulated to both prevent heat loss from high temperature compartment 306, prevent overheating of ambient temperature compartment 308, and make it easy and safe to handle.

Thermal management may be achieved using recuperator 310 having a high efficiency, for air preheating and energy recovery. Additionally, an ultra-low thermal conductance insulation, such as aerogel may be used to insulate high temperature compartment 306. During operation, process gases may be diluted with ambient air prior to exiting power generator system 300 in order to reduce the thermal signature and improve safety.

Ambient temperature compartment 308 includes an air processing sub-system 314, a fuel control 316, or optional pumping sub-system (not shown), a rechargeable battery 320, DC/DC converters 322 for electric control and battery charging, process controller 324 and a power conditioning sub-system 326.

Air processing sub-system 314 may include a speed-controlled air blower 328. Air blower 328 may supply a dilution air feed 330, a cathode air feed 332, and a reformer air feed 334. Dilution air feed 330 may mitigate the thermal signature of the portable power supply system. Cathode air feed 332 may supply reactant air to the cathode side of fuel cell stack 370. Reformer air feed 334 feeds air into a CPOX reformer 302.

Air blower 328 may be located within ambient temperature chamber 308. Dilution air feed may originate in ambient temperature chamber 308 and may mix with exhaust exiting recuperator 310 and dilute and cool the exhaust. Similarly, cathode air feed 332 may originate in ambient temperature chamber 308 and may proceed through recuperator 310 to be preheated before supplying reactant air to the cathode side of fuel cell stack 370. In like manner, reformer air feed originates in ambient temperature chamber 308 and supplies reformer 302 in high temperature chamber 306.

A butane fuel tank 336 may supply reactant gas to the anode side of stack 370. Butane may be self-pressurized due to its high vapor pressure to provide a reactant gas stream to stack 370. Other types of fuel may require a speed-controlled pump (not shown) to provide fuel to reformer 302.

Under operation, any residual combustible gases exiting fuel cell stack 370 may be burned in catalytic burner 304.

Start-up time for power generator system 300 may be controlled by the stack-heating rate, which may be up to around 100 C/min. Heating may be provided by CPOX reformer 302 or a separate burner (not shown) or an electric heater (not shown). Rechargeable battery 320 may be used to provide power to the load 340 and provide initial power for air blower 328 and system controller 324.

Power system 300 may be designed for instantaneous power. In such a design, rechargeable battery 320 may be sized to provide initial power to a user as well as power required for heating hot temperature chamber 306 and driving air blower 328, system controller 324. After start-up, power taken from stack 370 may recharge battery 320 and power air blower 328, system controller 324, and if needed other components of system 300.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

I claim:

1. A solid oxide fuel cell module comprising:
a housing including a walled structure defining a substantially enclosed interior cavity, wherein the housing includes an outer wall surface and an inner wall surface;
an aperture extending through the walled structure from the outer wall surface to the inner wall surface of the housing in fluid communication with the interior cavity; and
a tri-layer solid oxide fuel cell mounted to the housing forming a gas tight seal with the housing and aligned to substantially cover the aperture.

2. The solid oxide fuel cell module of claim 1, wherein the tri-layer solid oxide fuel cell includes:
a first electrode layer deposited on a metal support;
an electrolyte layer deposited on top of the first electrode layer; and
a second electrode layer deposited on top of the electrolyte layer.

3. The solid oxide fuel cell module of claim 2, wherein the first electrode layer is an anode electrode and the second electrode layer is a cathode electrode.

4. The solid oxide fuel cell module of claim 2, wherein the first electrode layer is a cathode electrode and the second electrode layer is an anode.

5. The solid oxide fuel cell module of claim 2, wherein the metal support includes a porous region bounded by a non-porous region.

6. The solid oxide fuel cell module of claim 5, wherein the first electrode layer, the electrolyte layer, and the second electrode layer are dimensioned to substantially cover the porous region of the metal support.

7. The solid oxide fuel cell module of claim 1, wherein the tri-layer solid oxide fuel cell is mounted to the outer surface of the housing forming a gas tight seal and aligned to substantially cover the aperture.

8. The solid oxide fuel cell module of claim 7, wherein the gas tight seal includes a glass sealing material.

9. The solid oxide fuel cell module of claim 7, wherein the gas tight seal includes a braze sealing material.

10. The solid oxide fuel cell module of claim 1, wherein the tri-layer solid oxide fuel cell is mounted to the inner surface of the housing forming a gas tight seal and aligned to substantially cover the aperture.

11. The solid oxide fuel cell module of claim 10, wherein the gas tight seal includes a glass material.

12. The solid oxide fuel cell module of claim 10, wherein the gas tight seal includes a braze sealing material.

13. The solid oxide fuel cell module of claim 6, further comprising:
a plurality of apertures extending through the walled structure from the outer wall surface to the inner wall surface of the housing in fluid communication with the interior cavity; and
a plurality of tri-layer solid oxide fuel cells joined to the housing by a sealing material forming a substantially gas impermeable seal between the non-porous region of the metal support and the outer wall surface, each of the plurality of tri-layer solid oxide fuel cells aligned with each of the plurality of apertures.

14. The solid oxide fuel cell module of claim 13, further comprising electrical interconnects configured to create an electron flow path from the first electrode layer of a first of the plurality of tri-layer solid oxide fuel cells to a second electrode layer of a second of the plurality of tri-layer solid oxide fuel cells.

15. The solid oxide fuel cell module of claim 14, wherein the electrical interconnects are substantially external to the housing.

16. The solid oxide fuel cell module of claim 15, wherein the electrical interconnects connect to the metal support of the first of the plurality of tri-layer solid oxide fuel cells and connect to a current collector attached to the second of the plurality of tri-layer solid oxide fuel cells.

17. The solid oxide fuel cell module of claim 1, further comprising:
a plurality of apertures extending through the walled structure from the outer wall surface to the inner wall surface of the housing in fluid communication with the interior cavity; and
a plurality of tri-layer solid oxide fuel cells joined to the housing by a sealing material forming a substaintially gas impermeable seal between the non-porous region of the metal support and the outer wall surface, each of the plurality of tri-layer solid oxide fuel cells aligned with each of the plurality of apertures.

18. The solid oxide fuel cell module of claim 17, wherein the electrical interconnects are substantially external to the housing.

19. The solid oxide fuel cell module of claim 18, wherein the electrical interconnects connect to the metal support of the first of the plurality of tri-layer solid oxide fuel cells and connect to a current collector attached to the second of the plurality of tri-layer solid oxide fuel cells.

20. The solid oxide fuel cell module of claim 17, further comprising electrical interconnects configured to create an electron flow path between the first electrode layer of a first of the plurality of tri-layer solid oxide fuel cells and a second electrode layer of a second of the plurality of tri-layer solid oxide fuel cells.

21. The solid oxide fuel cell module of claim 1, wherein the housing includes an elongate flat-box like shape.

22. The solid oxide fuel cell module of claim 21, wherein the elongate flat-box like shape includes:
a width sized to accommodate at least one solid oxide fuel cell assembly;
a thickness sized to permit the inner cavity to have sufficient gas permeable space to supply a reactant gas to the at least one solid oxide fuel cell assembly; and
a length sized to accommodate a plurality of side-by-side solid oxide fuel cells assemblies.

23. A fuel cell stack comprising:
a frame configured to couple with at least one solid oxide fuel cell module; and
a solid oxide fuel cell module coupled with the frame, wherein the solid oxide fuel cell module includes:
a housing forming a reactant gas cavity and having an outer surface and a mounting structure configured to couple with the frame;
at least one aperture in the housing, the aperture in fluid communication with the reactant gas cavity and the outer surface of the housing; and
at least one fuel cell assembly mounted to the surface of the housing and substantially covering the aperture thereby sealing the reactant gas cavity.

24. The solid oxide fuel cell stack of claim 23, wherein the frame comprises:
a housing coupler configured to couple the frame to the housing; and
at least one suspension member attached to the housing coupler and configured to suspend the solid oxide fuel cell stack within a portable power generation system.

25. The solid oxide fuel cell stack of claim 23, the
at least one fuel cell assembly includes:
a first electrode layer deposited on a metal support;
an electrolyte layer deposed on top of the first electrode layer; and
a second electrode layer deposited on top of the electrolyte layer.

26. The solid oxide fuel cell stack of claim 25, wherein the metal support includes a porous region bounded by a non-porous region.

27. The solid oxide fuel cell stack of claim 25, wherein the first electrode layer, the electrolyte layer, and the second electrode layer are dimensioned to substantially cover the porous region of the metal support.

28. A fuel cell stack comprising:
a metal support having a porous region and a non-porous region;
a solid oxide fuel cell deposited on the metal support, wherein the anode, cathode, and electrolyte of the solid oxide fuel cell substantially cover the porous region of the metal support;
a current collector attached to the cathode of the solid oxide fuel cell; and
an electrical interconnect attached to the current collector configured to provide a current path for electrons; and
an insulating housing configured to resist electrical current flow:
including at least one opening sized to be approximately coterminous with the porous region of the metal support;
defining a cavity configured to communicate a gaseous flow;
wherein the non-porous region of the metal supports is bonded to the insulating housing and the porous region of the metal support communicates with the gaseous flow.
